(19) United States
(12) Patent Application Publication
(10) Pub. No.: US 2015/0021883 A1
(43) Pub. Date: Jan. 22, 2015

(54) WHEEL STABILIZER

(71) Applicant: GM Global Technology Operations LLC, Detroit, MI (US)

(72) Inventors: Eric Roselli, Royal Oak, MI (US); Mark J. Mcguire, Amherstburg (CA); Vincent R. Gonzales, Warren, MI (US); Daniel K. Davis, Williamston, MI (US); Edward D. Moss, Commerce Township, MI (US)

(21) Appl. No.: 14/307,801

(22) Filed: Jun. 18, 2014

Related U.S. Application Data
(60) Provisional application No. 61/857,082, filed on Jul. 22, 2013.

(51) Int. Cl. B60R 19/00

(52) U.S. Cl. CPC B60R 19/00
USPC 280/727

(57) ABSTRACT

A number of variations include a wheel stabilizer.

### CROSS-REFERENCE TO RELATED APPLICATIONS

This application claims the benefit of U.S. Provisional Application No. 61/857,082 filed Jul. 22, 2013.

### TECHNICAL FIELD

The field to which the disclosure generally relates to includes vehicle wheel stabilizers.

### BACKGROUND

The vertical position of a wheel of a vehicle may be altered under certain circumstances. A vehicle wheel may undergo cross-car acceleration under certain circumstances.

### SUMMARY OF ILLUSTRATIVE VARIATIONS

A number of variations may include a product including a vehicle wheel stabilizer constructed and arranged for attachment to a vehicle rail.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a perspective view of a vehicle with portions removed illustrating a wheel stabilizer according to a number of variations.

FIG. 2 is a perspective view of a wheel stabilizer according to a number of variations.

FIG. 3 is a plan view with a portion of a vehicle rail sectioned illustrating a wheel stabilizer attached to a vehicle rail according to a number of variations.

### DETAILED DESCRIPTION OF ILLUSTRATIVE VARIATIONS

The following description of the variations is merely illustrative in nature and is in no way intended to limit the scope of the invention, its application, or uses.

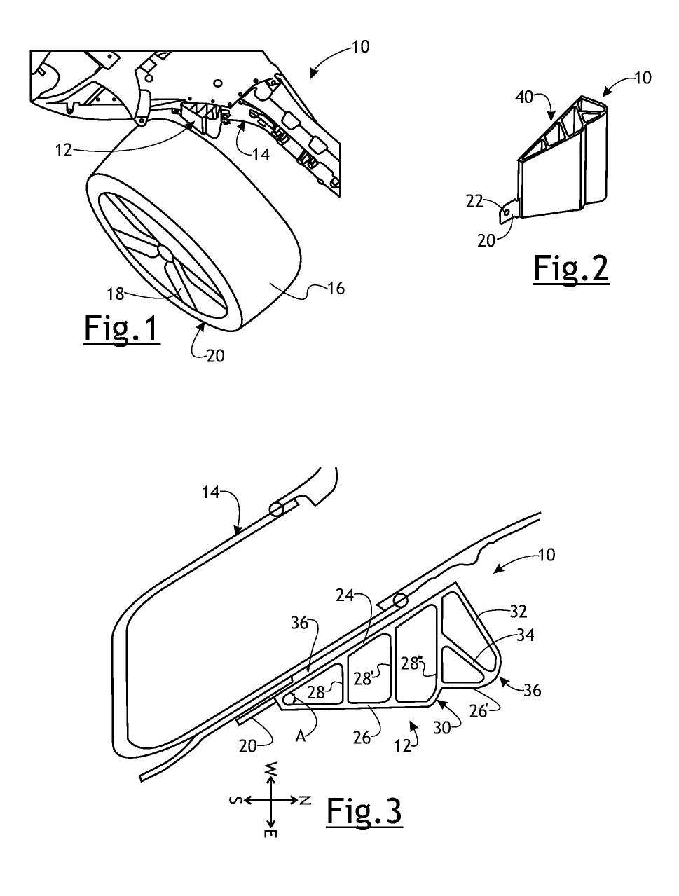

Referring now to FIG. 1, a number of variations may include a product 10 including a wheel stabilizer 12 which may be attached to a vehicle frame or rail system 14. The wheel stabilizer 12 may be constructed and arranged and attached to the rail system 14 to maintain the vertical position of a vehicle wheel 20 which may include a tire 16 received on a tire rim 18 and/or to slow the cross-car acceleration of the wheel 20 when a sudden load is applied thereto. Should a load be applied to the wheel 20, the stabilizer 12 maintains the vertical position of the wheel and may create a load bearing path through the wheel when a substantial load is suddenly applied to the wheel. In a number of variations, the wheel stabilizer may include a body portion 14 and a tab 20 extending from the body portion 40. The tab 20 may include a through-hole 22 formed therein to facilitate the attachment of the wheel stabilizer 12 to the rail system 14 of the vehicle by a fastener such as, but not limited to, a flow drill screw.

In a number of variations, for example as illustrated in FIG. 3, the wheel stabilizer 12 may include a base wall 24 constructed and arranged to be placed along a section of an outer wall 36 of a vehicle rail system 14. The base wall 24 may be connected to a wheel engagement wall 26. The wheel engagement wall 26 may be generally planar and run in the north-south direction of the vehicle and generally parallel to the direction of the vehicle traveling in a straight line. A second wheel engagement wall 26′ may be provided and connected to the first wheel engagement wall 26 by a step portion 30. The second wheel engagement wall 26 may be planar and run in the north-south direction parallel to the vehicle traveling in a straight line or parallel to a longitudinal axis of the vehicle. The first wheel engagement wall 26 may be spaced from and parallel to the second wheel engagement wall 26′. A plurality of spaced apart transverse walls may be provided and may include a first transverse wall 28 and a second transverse wall 28′, which may each extend from the base wall 24 to the first wheel engagement wall 26. A third transverse wall 28″ may extend from the base wall 24 to the second wheel engagement wall 26′. An end wall 28 may connect the base wall 24 to the second wheel engagement wall 26′. An angled brace wall 34 may extend from a corner 36 joining the second engagement wall 26′ and the end wall 32 to the third transverse wall 28″ at a location between the base wall 24 and the step portion 30.

In a number of variations the transverse walls 28, 28′, 28″, brace wall 34, and end wall 32 may be designed to crush or may be crushable under a sudden and substantial load. The wheel stabilizer 12 may be constructed and arranged to impede the acceleration of the wheel 20 when a sudden and substantial load is applied thereto.

As will be appreciated from FIG. 3, a number of variations may include a wheel stabilizer 12 wherein the base wall 24 is formed at an angle A with respect to the first wheel engagement wall 26 wherein the angle A is an acute angle. In a number of variations the base wall 24 and the first wheel engagement wall 26 may be spaced apart from each other. In a number of variations the base wall 24 and the first wheel engagement wall 26 may converge toward each other.

In a number of variations the wheel stabilizer may include an extruded metal. In a number of variations the wheel stabilizer may be a single piece of continuous non-joined metal. In a number of variations the wheel stabilizer is a continuous single piece extrusion including an aluminum alloy.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising: a wheel stabilizer for a vehicle comprising a base wall, a wheel engagement wall, and at least one crushable transverse wall extending between the base wall and the wheel engagement wall.

Variation 2 may include a product as set forth in Variation 1 further comprising a second crushable transverse wall spaced apart from the first crushable transverse wall and extending between the base wall and the first wheel engagement wall.

Variation 3 may include a product as set forth in any of Variations 1-2 wherein the wheel stabilizer comprises a tab having a through-hole formed therein constructed and arranged so that the wheel stabilizer may be attached to a vehicle rail.

Variation 4 may include a product as set forth in any of Variations 1-3 further comprising a second wheel engagement wall and a step portion connecting the first wheel engagement wall to the second wheel engagement wall, and wherein both the first wheel engagement wall and the second wheel engagement wall are planar.

Variation 5 may include a product as set forth in Variation 4 further comprising an end wall extending from the base wall and connected to the second wheel engagement wall.

Variation 6 may include a product as set forth in Variation 5 further comprising a third crushable transverse wall extending from the base wall to the second wheel engagement wall.

Variation 7 may include a product as set forth in Variation 6 further comprising an angled brace wall extending from the third crush wall to a corner portion joining the end wall and the second wheel engagement wall.

Variation 8 may include a product as set forth in any of Variations 1-7 wherein the wheel stabilizer comprises an extruded metal.

Variation 9 may include a product as set forth in any of Variations 1-8 wherein the wheel stabilizer is a single piece of continuous non-joined metal.

Variation 10 may include a product as set forth in any of Variations 1-9 wherein the wheel stabilizer is a continuous single piece extrusion comprising an aluminum alloy.

Variation 11 may include a product as set forth in any of Variations 1-10 further comprising a vehicle rail system and wherein the wheel stabilizer is attached to an outside wall of the vehicle rail system.

Variation 12 may include a product as set forth in Variation 11 further comprising a wheel positioned adjacent the wheel stabilizer and connected to the rail system.

Variation 13 may include a product as set forth in any of Variations 1-12 wherein the wheel stabilizer is a continuous single piece extrusion consists essentially of an aluminum alloy.

Variation 14 may include a product comprising a vehicle wheel stabilizer constructed and arranged for attachment to a vehicle rail.

The above description of select variations within the scope of the invention is merely illustrative in nature and, thus, variations or variants thereof are not to be regarded as a departure from the spirit and scope of the invention.

What is claimed is:

1. A product comprising:
a wheel stabilizer for a vehicle comprising a base wall, a wheel engagement wall, and at least one crushable transverse wall extending between the base wall and the wheel engagement wall.

2. A product as set forth in claim 1 further comprising a second crushable transverse wall spaced apart from the first crushable transverse wall and extending between the base wall and the first wheel engagement wall.

3. A product as set forth in claim 1 wherein the wheel stabilizer comprises a tab having a through-hole formed therein constructed and arranged so that the wheel stabilizer may be attached to a vehicle rail.

4. A product as set forth in claim 1 further comprising a second wheel engagement wall and a step portion connecting the first wheel engagement wall to the second wheel engagement wall, and wherein both the first wheel engagement wall and the second wheel engagement wall are planar.

5. A product as set forth in claim 4 further comprising an end wall extending from the base wall and connected to the second wheel engagement wall.

6. A product as set forth in claim 5 further comprising a third crushable transverse wall extending from the base wall to the second wheel engagement wall.

7. A product as set forth in claim 6 further comprising an angled brace wall extending from the third crush wall to a corner portion joining the end wall and the second wheel engagement wall.

8. A product as set forth in claim 1 wherein the wheel stabilizer comprises an extruded metal.

9. A product as set forth in claim 1 wherein the wheel stabilizer is a single piece of continuous non-joined metal.

10. A product as set forth in claim 1 wherein the wheel stabilizer is a continuous single piece extrusion comprising an aluminum alloy.

11. A product as set forth in claim 1 further comprising a vehicle rail system and wherein the wheel stabilizer is attached to an outside wall of the vehicle rail system.

12. A product as set forth in claim 11 further comprising a wheel positioned adjacent the wheel stabilizer and connected to the rail system.

13. A product as set forth in claim 1 wherein the wheel stabilizer is a continuous single piece extrusion consists essentially of an aluminum alloy.

14. A product comprising a vehicle wheel stabilizer constructed and arranged for attachment to a vehicle rail.
